(19) United States
(12) Patent Application Publication
(10) Pub. No.: US 2002/0195388 A1
(43) Pub. Date: Dec. 26, 2002

(54) Advanced leaf disc filter segment

(76) Inventors: Stephen E. Sierens, Clermont, FL (US); Walter L. Smith JR., Deland, FL (US); James Allen Morton, Orange City, FL (US); Stephen Neubert, Edgewater, FL (US); James A. McGrath, Winter Park, FL (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/153,175

(22) Filed: May 20, 2002

Related U.S. Application Data
(60) Provisional application No. 60/292,812, filed on May 22, 2001.

(51) Int. Cl. B01D 33/23

(52) U.S. Cl. 210/486; 210/498

(57) ABSTRACT

An improved leaf disc filter segment having a central drainage plate and a hub defining a central cavity. The drainage plate has radial beams and diametrical rings. The diametrical rings extend generally one-half of the height of the radial beams and are configured to alternately extend from either an upper surface or a lower surface of the radial beams such that the diametrical rings are alternately positioned in either an upper portion or lower portion of the drainage plate. The radial beams and diametrical rings define radial flow paths through the drainage plate to the central cavity through openings in the hub. The radial beams and diametrical rings are configured to provide trapezoidal openings of generally constant area to the flow channels of the drainage plate.

The benefit under 35 U.S.C. § 119(e) of U.S. provisional application entitled ADVANCED LEAF DISC FILTER SEGMENT, Serial No. 60/292,812, filed May 22, 2001, is hereby claimed and the disclosure of which is hereby incorporated by reference in its entirety.

### BACKGROUND OF THE INVENTION

1. Field of the Invention

This invention relates to filters, and in particular, to disc type segmented filters for use in high-viscosity and high-pressure applications.

2. Description of the Related Art

Conventional segment-type filter units often include an assembly of two or more individual disc filter segments stacked at their respective hubs on a central common filtrate collection tube within a filter housing. The disc filter segments are positioned such that the filter surfaces are spaced from those of the adjacent filter segment discs to allow inflow of the fluid to be filtered from both sides of the disc. Each filter segment is made up of a central drainage core and support mesh sandwiched between layers of filter media. The housing is supplied with fluid at a relatively high pressure while the central collection tube is maintained at a lower pressure so that fluid flows from the housing through the filtering medium into the drainage core. The filtered fluid then passes to the central collection tube.

Each disc filter segment typically includes a filter medium affixed to the surface of a filter support mesh and drainage core. The filter medium may include any of many well-known materials, for example, a sintered powdered metal material, sintered fiber metal, finely woven metal or synthetic materials, or polymer membranes. The filter core generally serves the purposes of stiffening the disc, supporting the filter medium, and providing a porous interior through which the filtrate can drain to the hub after passing through the filter medium.

The support mesh in the drainage core constitutes a significant resistance to radial flow of the filtrate through the drainage core. Overcoming this resistance requires the filter units to be operated at higher operating pressures. This resistance also causes non-uniform flow velocity through the filter medium. Non-uniform flow velocity through the filter medium results in a higher residence time of some of the filtrate in the segment. This non-uniform residence time is of particular concern in polymer melt filtration applications, as most polymers experience molecular weight shifts due either to polymerization or degradation when subject to high temperatures.

Another consideration in the design of filter segments is the elimination of “dead spots,” or areas of stagnation, where filter fluid, especially polymer melt, can stagnate and decompose during extended exposure to high temperature. Such areas of stagnation also interfere with cleaning of the disc filter segment as areas of stagnation resist penetration of cleaning agents and any degraded polymer retained in dead spots after cleaning. This degraded polymer contaminates the fluid being filtered when the disc filter segment is put back in use.

### SUMMARY OF THE INVENTION

One embodiment of the invention is directed to a drainage plate for a leaf disc filter segment. The drainage plate has a hub defining a central cavity, wherein the hub has a plurality of orifices therein leading to the central cavity. The drainage plate has a plurality of beams extending radially from the hub, and a plurality of diametrical rings, wherein the diametrical rings extend less than the entire height of the radially extending beams, and wherein the diametrical rings are positioned in either an upper portion or a lower portion of the drainage plate. In one embodiment, the diametrical rings are configured to alternately extend from either an upper portion of the radial beams or a lower portion of the radial beams. In another embodiment, the radial beams and diametrical rings form generally straight radial flow paths in the drainage plate to the orifices in the central cavity, wherein said flow paths are between the radial beams and over the diametrical rings positioned in the lower portion of the drainage plate and under the diametrical rings positioned in the upper portion of the drainage plate.

Another embodiment of the invention is directed to a leaf disc filter segment. The leaf disc filter segment has two perforation plates, a filter medium supported on each of said two perforation plates, and a drainage plate sandwiched between said two perforation plates. The drainage plate has a hub defining a central cavity, wherein the hub has a plurality of orifices therein leading to the central cavity. The drainage plate also has a plurality of beams extending radially from the hub and a plurality of diametrical rings, wherein the diametrical rings extend less than the entire height of the radially extending beams, and wherein the diametrical rings are positioned in either an upper portion or a lower portion of the drainage plate.

### BRIEF DESCRIPTION OF THE DRAWINGS

These and other objects and features of the invention will become more fully apparent from the following description and appended claims taken in conjunction with the following drawings, where like reference numbers indicate identical or functionally similar elements.

FIG. 1 is a cutaway elevation view of one embodiment of a leaf disc filter segment.

FIG. 2 is a cross-sectional view of the leaf disc filter segment taken along line A-A of FIG. 1.

FIG. 3 is a perspective view of a drainage plate in the leaf disc filter element of FIG. 1.

FIG. 4 is a top view of a portion of the drainage plate of FIG. 3.

### DETAILED DESCRIPTION OF THE INVENTION

A detailed description of an embodiment of the invention is provided below. While the invention is described in conjunction with that embodiment, it should be understood that the invention is not limited to any one embodiment. On the contrary, the scope of the invention is limited only by the appended claims and the invention encompasses numerous alternatives, modifications and equivalents. For the purpose of example, numerous specific details are set forth in the following description in order to provide a thorough understanding of the invention. The invention may be practiced according to the claims without some or all of these specific details. For the purpose of clarity, technical material that is known in the technical fields related to the invention has not been described in detail so that the invention is not unnecessarily obscured.

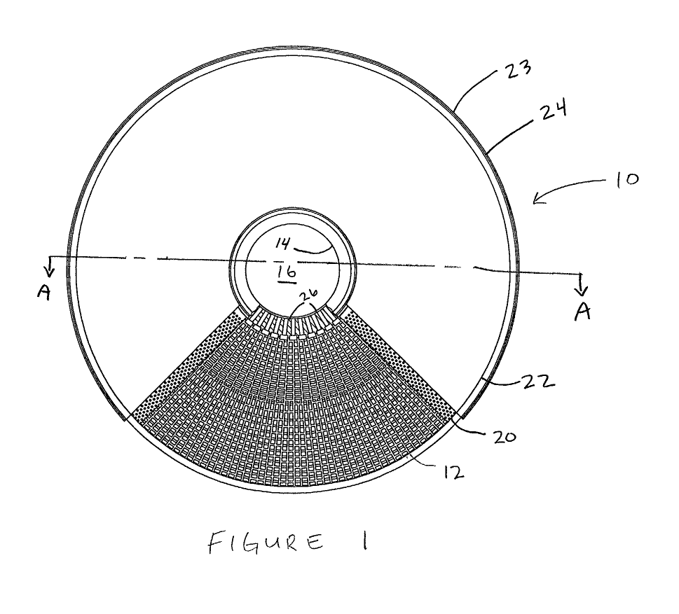

FIG. 1 is a partial cutaway view of an embodiment of a leaf disc filter segment 10. As shown, the leaf disc filter segment 10 has a generally circular drainage plate 12 as a central layer thereof. The drainage plate 12 has an interior hub 14 defining a central cavity 16 which passes through the interior of the leaf disc filter segment 10. In one embodiment the hub 14 is shaped as a circular ring, although other shapes, such as hexagonal, octagonal or the like can be used. The drainage plate 12 has an upper perforation plate 20 and lower perforation plate 21 (not shown) mounted thereon. Preferably, the upper and lower perforation plates 20 and 21 are substantially identical. The perforation plates 20 and 21 each support a filter medium 22. The filter medium 22 supported by the upper perforation plate 20 is sealed to the filter medium 22 supported by the lower perforation plate 21 at an outer edge 23 by a welded bead 24. Those skilled in the art will understand that there are other methods of sealing the outer edges of the filter media 22.

While the exemplary leaf disc filter segment of FIG. 1 is shown to be of circular shape, the leaf disc filter segment 10 may be made in any practical shape, for instance, elliptical or polygonal. The diameter of such a disc made in circular plan form may be made having any convenient diameter, including the most commonly used industrial sizes of 7, 8 ¾, 10, and 12 inch outer diameters. In one embodiment, several leaf disc filter segments 10 are stacked on a central drainage tube or similar positioning device (not shown) and placed in a filter housing (not shown) as is common in the art. Fluid to be filtered is introduced into the housing at a high pressure so that the fluid passes through the filter medium 22. The fluid then migrates through channels in the drainage plate 12 as will be described below to the central cavity 16 and the drainage tube therein, which is maintained at lower pressure. Pressure differentials over the leaf disc filter segment 10 in industrial operations involving, for example, the filtration of molten polymers, generally range from 800 psi to over 5,000 psi. In filtering operations where a constant volume flow is maintained, the formation of a filter cake by impurities removed from the fluid being filtered will cause the pressure differential across the filter to raise from an initial lower value to higher values over time until a practical limit is reached. Periodically, the filter segments 10 are removed and cleaned for reuse or replaced.

The drainage plate 12 and hub 14 can be manufactured as a single integral piece by investment casting. Alternately, the drainage plate 12 and hub 14 can be manufactured separately and joined by welding or other known joining methods. Also, one skilled in the art will understand that other method of manufacturing such as powder metallurgy and laser deposition can be used. In one embodiment, the drainage plate 12 and hub 14 are manufactured from a corrosion and heat resistant material, such as 316 or 316L stainless steel. Other =b 300 and 400 series stainless steels and 17-4 precipitation hardened steel can also be used. Additionally, other metals such as aluminum, aluminum alloys, titanium, titanium alloys and other corrosion and heat resistant alloys can also be used.

The hub 14 has several orifices 26 defined therein that allow fluid flowing through the drainage plate 12 to pass through the hub 14 and reach the central cavity 16. In one embodiment, the hub 14 is cast as a single piece with the orifices 26 therein using known investment casting techniques. In an alternate embodiment, the hub 14 is cast with a first portion (not shown) having several channels passing from the outer circumference to the inner circumference of the first portion. The hub 14 also has a second portion (not shown), shaped generally as a flat washer, that is placed over the lower portion such that the second portion provides an upper surface enclosing the channels in the first portion to form orifices 26 through the hub 14. In this two portion embodiment, the first portion has several expanding rivets thereon which are received through the second portion in order to secure the second portion to the first portion. Alternately, the first portion and the second portion can be welded together.

FIG. 1 further shows the perforation plate 20 as having porous openings 27 which allow filtrate to flow though such that the filtrate can reach flow channels formed in the drainage plate 12 that will be more fully described below. The perforation plate 20 is fabricated from stainless steel, such as 300 and 400 series stainless steels. Other metals, such as 17-4 precipitation hardened steel aluminum, aluminum alloys, titanium, titanium alloys and other corrosion and heat resistant alloys can also be used for the perforation plate 20. The perforation plate can have various designs that are sufficiently porous to allow the filtrate to readily flow to flow channels in the drainage plate 12 and also provide sufficient strength to support the filter medium 22. The perforation plate 20 can be of various thicknesses depending on the desired strength. The perforation plate 20 can also have various perforation patterns therein to provide varying flow characteristics. A wire mesh may also be substituted for the perforation plate 20.

The filter medium 22 can be any filter medium suitable to a particular filtering application. Where corrosive elements are to be removed by filtration, a ceramic filter medium can be used. For some low pressure applications, membrane filtering material, such as, for example, Teflon or other polymer, may be used. The filter medium 22 can have a graded pore size outer section and a constant pore size inner portion to provide longer filter segment life. Alternately, a filter medium with a continuously graded pore size can be used. In another embodiment, the filter medium 22 can have a constant pore size.

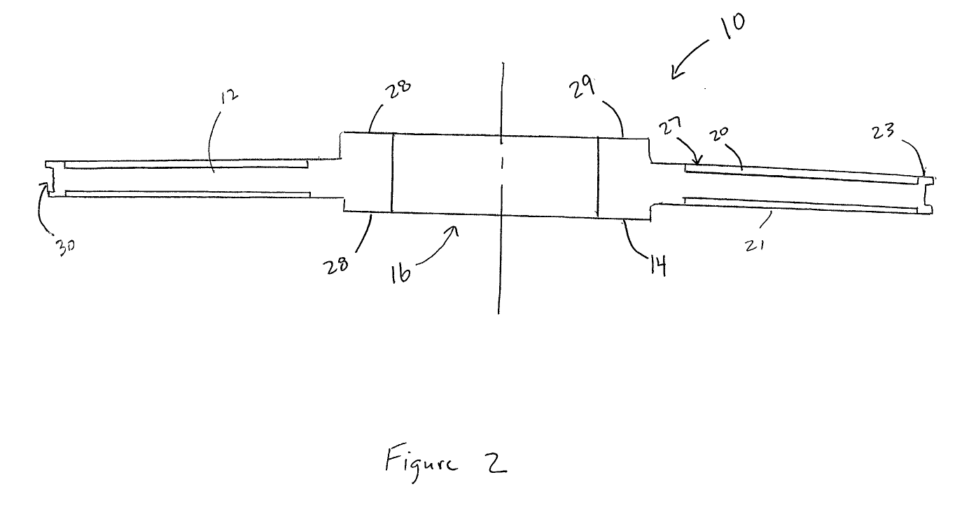

FIG. 2 is a cross-sectional view of the leaf disc filter segment 10 and illustrates that the hub 14 is formed with a flat surface 28 on either side of the hub 14 such that, when multiple leaf disc filter segments 10 are stacked together, the flat surface 28 of a first leaf disc filter segment 10 is in contact with flat surfaces 28 of the adjacent leaf disc filter segments. In such a stacked configuration, the leaf disc filter segments 10 are held in alignment by the central drainage tube or similar positioning device (not shown) inserted into the central cavity 16. In this configuration, surfaces of the filter medium 22 of adjacent leaf disc filter segments 10 are spaced from one another allowing the fluid to be filtered to come in contact with the filter medium 22 on each side of each leaf disc filter segment 10. Additionally, in one embodiment, a high side 29 of the hub 14 contains an O-ring groove (not shown). When multiple leaf disc filter segments 10 are stacked together, an O-ring (not shown) is received in the O-ring groove in one leaf disc filter segment 10 and mates with the flat surface 28 of the adjacent segment disc.

An external support spacer (not shown) is particularly suitable for high pressure applications where distortion of the filter medium 22 is of concern or where it is desired to link the leaf disc filter elements 10 of the stack to one another to provide additional support to the individual elements and increase the rigidity of the stack. This embodiment includes an external support spacer which lies in contact with the upper surface of one leaf disc filter segment 10 and the lower surface of the adjacent leaf disc filter segment 10 in a stacked configuration. In one embodiment, the support spacer has several arms, for example eight, which provide spacing between adjacent leaf disc filter segments 10 and provide stiffness to the stack of discs. Of course, any number of arms that provide sufficient support and of a configuration to allow sufficient fluid flow can be used. Alternately, the disc filter segments can be used without the support spacer, thereby allowing additional discs to fit in a common sized housing.

FIG. 2 additionally shows that in one embodiment, the perforation plate 20 is received in a recess 29 in the drainage plate 12. A groove or taper 30 formed in the outer edge 23 of the drainage plate 12 receives the weld bead 24 of FIG. 1. The leaf disc filter segment 10 is held together in fixed relation by these weld beads 24.

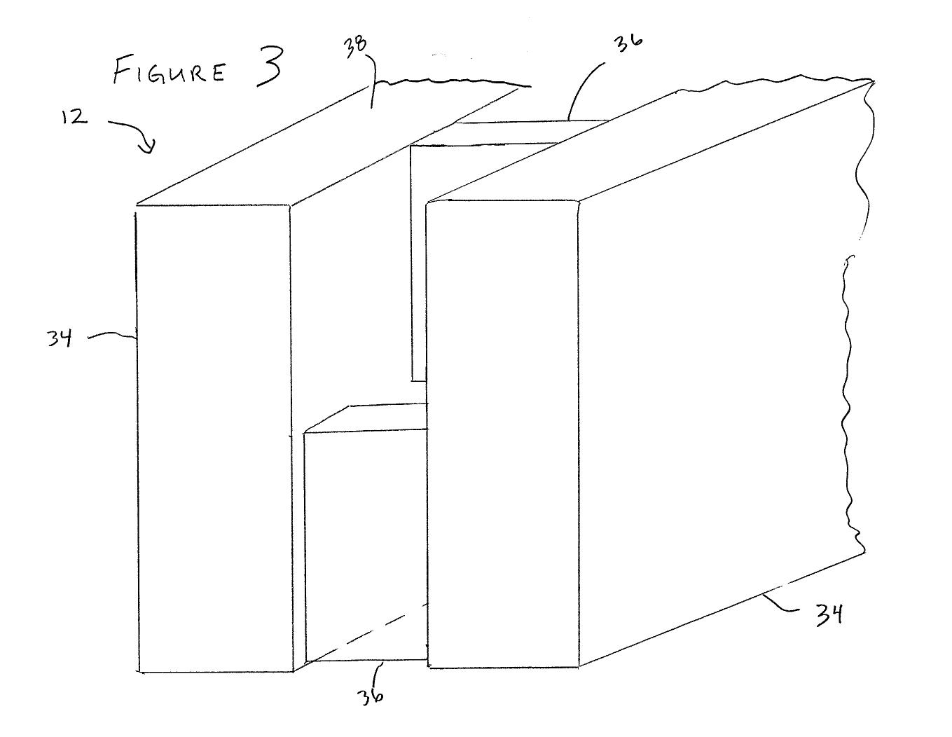

FIG. 3 is a perspective view of the drainage plate 12 and illustrates that the drainage plate 12 has several radial beams 34 and diametrical rings 36. The diametrical rings 36 extend only a portion of the height of the radial beams 34. Preferably, the diametrical rings extend between ¼ to ¾ the height of the radial beams. More preferably, the diametrical rings 36 extend generally one-half of the height of the radial beams 34. The diametrical rings are configured extend from either an upper surface 38 of the radial beams 34 or a lower surface (not shown) of the radial beams 34. Preferably, the diametrical rings are configured to alternately extend from the upper surface 38 of the radial beams 34 or the lower surface (not shown) of the radial beams 34. In such configuration, the diametrical rings 36 are alternately positioned in either the upper portion or the lower portion of the drainage plate 12. This configuration forms radial flow paths in the drainage plate 12 to the orifice 16 in-between the radial beams 34 and over the diametrical rings 36 positioned in the lower portion of the drainage plate 12 and under the diametrical rings 36 positioned in the upper portion of the drainage plate 12. The radial flow paths are generally straight in the radial direction and pass over or under the diametrical rings in a wave-like pattern.

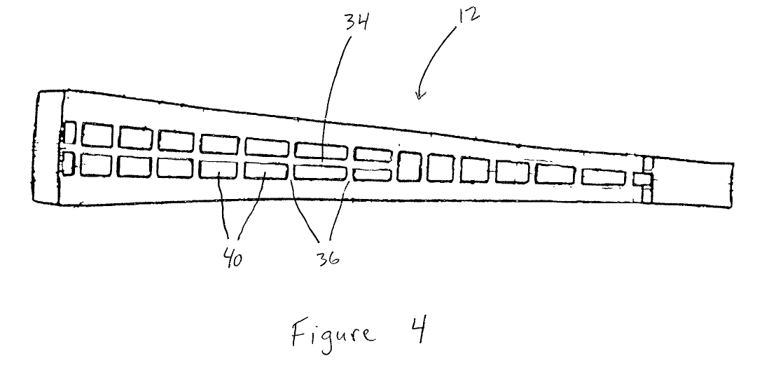

FIG. 4 illustrates a top view of a portion of the drainage plate 12 with the filter medium 22 (FIG. 1) removed for clarity. The radial beams 34 and diametrical rings 36 form trapezoidal passages 40 through which filtrate flowing through the filter medium 22 (not shown) is received into the drainage plate 12. In one embodiment, the diametrical rings 36 are spaced such that the trapezoidal passages 40 are of a generally constant area. This allows a substantially constant flux rate flow per unit area across the filter medium 22. Various portions of the drainage plate 12 can be configured to have different patterns of trapezoidal passages 40.

In one embodiment, the radial beams 34 are tapered such that the cross-sectional area of the drainage plate 12 decreases with increasing distance from the hub 14. Therefore, the cross-sectional area of the flow path increases from the outer diameter of the drainage plate 12 to the hub 14 to accommodate accumulated flow in the drainage plate 12. While the radial beams 34 may be tapered in any convenient configuration, it is preferable that they be formed to maximize filter performance by creating a substantially uniform pressure differential over the filter medium 22, thus maintaining a uniform fluid flow over the filtering surface of the filter segment 10. Alternately, the radial beams 34 can be of generally uniform size such that the cross-sectional area of the drainage plate 12 is uniform with respect to distance from the hub 14.

Specific blocks, sections, devices, functions and modules have been set forth. However, a skilled technologist will recognize that there are many ways to partition the system of the invention, and that there are many parts, components, modules or functions that may be substituted for those listed above. While the above detailed description has shown, described, and pointed out fundamental novel features of the invention as applied to various embodiments, it will be understood that various omissions and substitutions and changes in the form and details of the system illustrated may be made by those skilled in the art, without departing from the intent of the invention.

What is claimed is:

1. A drainage plate for a leaf disc filter segment comprising:
a hub defining a central cavity, said hub having a plurality of orifices therein leading to the central cavity;
a plurality of beams extending radially from the hub;
a plurality of diametrical rings, wherein the diametrical rings extend less than the entire height of the radially extending beams, and wherein the diametrical rings are positioned in either an upper portion or a lower portion of the drainage plate.

2. The drainage plate of claim 1, wherein the diametrical rings are configured to alternately extend from either an upper portion of the radial beams or a lower portion of the radial beams.

3. The drainage plate of claim 1, wherein the radial beams and diametrical rings form generally straight radial flow paths in the drainage plate to the orifices in the central cavity, wherein said flow paths are between the radial beams and over the diametrical rings positioned in the lower portion of the drainage plate and under the diametrical rings positioned in the upper portion of the drainage plate.

4. The drainage plate of claim 1, wherein the plurality of orifices lead from an outer circumference of the hub to an inner circumference of the hub.

5. The drainage plate of claim 1, wherein the drainage plate is manufactured as a single piece.

6. The drainage plate of claim 1, wherein the drainage plate is manufactured by investment casting.

7. The drainage plate of claim 1, wherein the drainage plate is manufactured as a plurality of pieces such that the radial beams and diametrical rings are cast as an integral plate core and the hub is cast as a separate piece, wherein said plate core and said hub are welded together.

8. The drainage plate of claim 1, wherein the hub is cast as a single metallic piece.

9. The drainage plate of claim 1, wherein the hub comprises a first portion with a plurality of channels therein and a second portion riveted to said first portion.

10. The drainage plate of claim 1, wherein the drainage plate is stainless steel.

11. The drainage plate of claim 1, wherein the radial beams and diametrical rings form a plurality of trapezoidal passages, wherein the trapezoidal passages have a substantially constant area.

12. A leaf disc filter segment comprising:
two perforation plates;
a filter medium supported on each of said two perforation plates;
a drainage plate sandwiched between said two perforation plates, said drainage plate comprising:
a hub defining a central cavity, said hub having a plurality of orifices therein leading to the central cavity;
a plurality of beams extending radially from the hub;
a plurality of diametrical rings, wherein the diametrical rings extend less than the entire height of the radially extending beams, and wherein the diametrical rings are positioned in either an upper portion or a lower portion of the drainage plate.

13. The leaf disc filter of claim 12, wherein the diametrical rings are configured to alternately extend from either an upper portion of the radial beams or a lower portion of the radial beams.

14. The leaf disc filter of claim 12, wherein the radial beams and diametrical rings form generally straight radial flow paths in the drainage plate to the orifices in the central cavity, wherein said flow paths are between the radial beams and over the diametrical rings positioned in the lower portion of the drainage plate and under the diametrical rings positioned in the upper portion of the drainage plate.

15. The leaf disc filter of claim 12, wherein the plurality of orifices lead from an outer circumference of the hub to an inner circumference of the hub.

16. The leaf disc filter of claim 12, wherein the drainage plate is manufactured as a single integral piece.

17. The leaf disc filter of claim 12, wherein the drainage plate is manufactured by investment casting.

18. The leaf disc filter of claim 12, wherein the drainage plate is manufactured as a plurality of pieces such that the radial beams and diametrical rings are cast as an integral plate core and the hub is cast as a separate piece, wherein said plate core and said hub are welded together.

19. The leaf disc filter of claim 12, wherein the hub is cast as a single metallic piece.

20. The leaf disc filter of claim 12, wherein the hub comprises a first portion with a plurality of channels therein and a second portion riveted to said first portion.

21. The leaf disc filter of claim 12, wherein the drainage plate is stainless steel.

22. The leaf disc filter of claim 12, wherein the radial beams and diametrical rings form a plurality of trapezoidal passages, wherein the trapezoidal passages have a substantially constant area.

23. A leaf disc filter segment comprising:
two perforation plates;
a filter medium supported on each of said two perforation plates;
a drainage plate sandwiched between said two perforation plates, said drainage plate comprising:
a hub means for defining a central cavity and passing fluid flow to said central cavity;
radial support means for supporting said perforation plates;
diametrical support means for supporting said perforation plates and for cooperating with said radial support means to provide generally straight radial flow paths to the hub means.

24. The leaf disc filter segment of claim 23, wherein said diametrical support means extend generally one-half of the height of said radial support means and are alternately positioned in either the upper portion or lower portion of the drainage plate.

25. The leaf disc filter segment of claim 23, wherein the diametrical support means are configured to alternately extend from either an upper portion of said radial support means or a lower portion of said radial support means.

26. A leaf disc filter segment comprising:
two perforation plates;
a filter medium supported on each of said two perforation plates;
a drainage plate sandwiched between said two perforation plates, said drainage plate comprising:
a hub defining a central cavity, said hub having a plurality of orifices therein leading to the central cavity;
a plurality of beams extending radially from the hub;
a plurality of diametrical rings, wherein the diametrical rings extend from either an upper portion of the radial beams or a lower portion of the radial beams and are of a height that is smaller than the height of the radially extending beams so as to be positioned in either an upper portion or a lower portion of the drainage plate to form generally straight radial flow paths in the drainage plate to the orifices in the central cavity, wherein said flow paths are between the radial beams and over the diametrical rings positioned in the lower portion of the drainage plate and under the diametrical rings positioned in the upper portion of the drainage plate.
